(19) United States
(12) Patent Application Publication
(10) Pub. No.: US 2024/0412181 A1
(43) Pub. Date: Dec. 12, 2024

(54) DECOUPLING NATIVE AND NON-NATIVE TOKENS IN BLOCKCHAIN TRANSACTIONS

(71) Applicant: Circle Internet Financial Limited, Dublin (IE)

(72) Inventors: Huawei GU, Boston, MA (US); Hao MIN, San Mateo, CA (US); Arne HUANG, Las Vegas, NV (US)

(21) Appl. No.: 18/332,490

(22) Filed: Jun. 9, 2023

(51) Int. Cl. G06Q 20/10; G06Q 20/36; G06Q 20/38

(52) U.S. Cl. CPC G06Q 20/10; G06Q 20/367; G06Q 20/389

(57) ABSTRACT

Certain aspects of the present disclosure provide techniques and apparatus for efficiently processing transactions on a blockchain. An example method generally includes receiving, at a relay service, a request to execute a transaction on a blockchain. Generally, the request includes a request to transfer a quantity of a first type of token on the blockchain from a transmitter wallet to a receiver wallet identified in the request and incurs a transaction overhead on the blockchain in a second type of token. The request is modified based on the quantity of the first type of token, the transaction overhead in the second type of token, and a policy defining a source from which the transaction overhead is to be retrieved. The transaction is executed on the blockchain based on the modified request without transferring the second type of token from the transmitter wallet to satisfy the transaction overhead.

### INTRODUCTION

Aspects of the present disclosure relate to transactions in blockchain systems, and more specifically to techniques for improving processing and resource utilization efficiency in performing transactions on a blockchain.

### BACKGROUND

Blockchains can be used in various decentralized systems to provide a ledger of transactions that have occurred within these decentralized systems. Generally, a blockchain may include a chain of blocks, in which latest block includes some information about a transaction that occurred and a reference to an immediate predecessor block, which may be a hashed value of the previous block. Because the reference to the immediate predecessor block may be a value derived from the immediate predecessor block, verification of the transactions in the blockchain may be performed by ensuring that a hash of a block resolves to the same value as that stored as a reference to the immediate predecessor block in a succeeding block in the blockchain. If there is a mismatch between a computed hash of a block and the hashed value of the block in a succeeding block in the blockchain, validation of the blockchain may fail.

Generally, each transaction performed on a blockchain may incur a transaction overhead (also known as a “gas fee”) to cover the computational expense involved in performing a transaction, verifying the transaction, and propagating transaction records across nodes participating in processing transactions on the blockchain. Further, the computational expense involved in performing a transaction on a blockchain may be significant, and the amount of time needed to complete a transaction may vary based on the number of transactions being performed at any given time on the blockchain. To manage the backlog of transactions being processed on a blockchain, thus, transaction overheads incurred in processing a transaction may scale with the amount of transactions pending processing on the blockchain. Transaction overheads may increase as the number of pending transactions on the blockchain increases and may correspondingly decrease as the number of pending transactions on the blockchain decreases.

Accordingly, techniques are needed to allow for computationally efficient processing of transactions on a blockchain.

### BRIEF SUMMARY

Certain embodiments provide a computer-implemented method for efficiently processing transactions on a blockchain. An example method generally includes receiving, at a relay service, a request to execute a transaction on a blockchain. Generally, the request includes a request to transfer a quantity of a first type of token on the blockchain from a transmitter wallet to a receiver wallet identified in the request and incurs a transaction overhead on the blockchain in a second type of token. The request is modified based on the quantity of the first type of token, the transaction overhead in the second type of token, and a policy defining a source from which the transaction overhead is to be retrieved. The transaction is executed on the blockchain based on the modified request without transferring the second type of token from the transmitter wallet to satisfy the transaction overhead.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing system in which transactions are performed on a blockchain through a relay service, according to embodiments of the present disclosure.

FIG. 2 is a flow diagram illustrating execution of a transaction on a blockchain through a relay service in which the recipient of the transaction incurs the transaction overhead for performing the transaction on the blockchain, according to embodiments of the present disclosure.

FIG. 3 is a flow diagram illustrating execution of a transaction on a blockchain through a relay service in which the transmitter associated with the transaction incurs the transaction overhead for performing the transaction on the blockchain, according to embodiments of the present disclosure.

FIG. 4 is a flow diagram illustrating execution of a transaction on a blockchain through a relay service in which a relay service incurs the transaction overhead for performing the transaction on the blockchain, according to embodiments of the present disclosure.

FIG. 5 illustrates example operations for executing a transaction on a blockchain through a relay service, according to embodiments of the present disclosure.

FIG. 6 illustrates an example system on which embodiments of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Transactions in cryptocurrency systems may be represented as blocks in a blockchain that track a universe of transactions performed using the cryptocurrency system. In these cryptocurrency systems, processed transactions may not be modified at a later date, thus providing an immutable ledger of the transactions performed using the cryptocurrency system.

In some cases, blockchains may support transactions on a native token, or cryptocurrency, as well as tokens built on top of the blockchain (also referred to as “non-native tokens). In such a case, transactions may be performed by transferring non-native tokens from a transmitter wallet to a recipient wallet. However, while these transactions may involve transferring a quantity of a non-native token from a transmitter wallet to a recipient wallet, the underlying transaction recorded on the blockchain may incur a transaction overhead (or “gas fee”) denominated in the native token for the blockchain. If a user does not have a sufficient amount of native tokens in that user's wallet to cover the transaction overhead, the user may perform additional transactions in order to obtain an amount of native tokens that will allow the user to satisfy the transaction overhead for the original transaction. For example, the user can obtain tokens from an exchange by exchanging some amount of a non-native token for an equivalent amount of a native token for the blockchain, by purchasing some amount of the non-native token using traditional finance rails, or the like. However, because these transactions may also be recorded on the blockchain, these transactions may incur additional transaction overheads for processing, which may use power, processing time, memory, network resources, and other compute resources, and may significantly delay the completion of the original transaction (as the completion of these exchange transactions may be a prerequisite for the completion of the original transaction).

Aspects of the present disclosure provide techniques for performing transactions on a blockchain through a relay service that allows for transactions to be efficiently performed between a transmitter wallet and a recipient wallet. As discussed in further detail herein, the relay service may allow recipient parties to define policies for covering transaction overheads incurred on the blockchain when performing transactions between a transmitter party and a recipient party. These policies may, for example, define which party covers the transaction overhead and allows for transactions to be performed between a transmitter wallet and a recipient wallet using only a first type of token (e.g., a non-native token exchanged on a blockchain), while still allowing for the transaction overhead to be covered using a second type of token (e.g., a native token associated with the blockchain). By allowing for transactions to be performed through a relay service that coordinates the exchange of tokens between the transmitter wallet and the recipient wallet and coordinates the coverage of a transaction overhead associated with the transaction, the number of individual transactions which may be performed in order to exchange tokens (and potentially other items) between a transmitter wallet and a receiver wallet may be reduced, as neither the user associated with the transmitter wallet nor the user associated with the receiver wallet may need to perform transactions to obtain the second type of token prior to exchanging a quantity of the first type of token between the transmitter wallet and the receiver wallet. Thus, aspects of the present disclosure may reduce the computational expense incurred in processing transactions involving non-native tokens on a blockchain, reduce power expenditure used in processing such transactions, and accelerate the processing of such transactions.

### Example Transaction Processing on a Blockchain Through a Relay Service for Managing Transaction Overhead Coverage

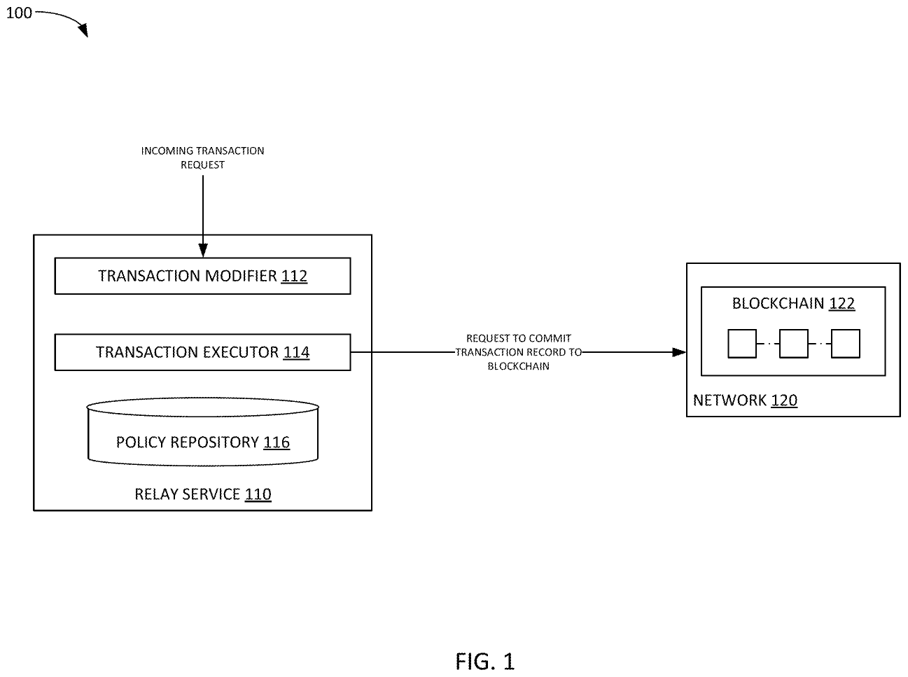

FIG. 1 illustrates an example computing environment 100 in which transactions are performed on a blockchain through a relay service, according to aspects of the present disclosure. As discussed, these transactions may be performed in multi-token environments in which the blockchain supports the execution of transactions involving a first type of token (e.g., a non-native token built on top of the blockchain) that incur transaction overheads denominated in a second type of token (e.g., a native token defined for the blockchain). As illustrated, computing environment 100 includes a relay service 110 and a network 120.

Relay service 110 generally receives incoming transaction requests to transfer a quantity of a first type of token from a transmitter wallet to a receiver wallet and processes these transactions to minimize, or at least reduce, the total number of transactions committed to the blockchain for verification. As illustrated, relay service 110 includes a transaction modifier 112, transaction executor 114, and policy repository 116.

Transaction modifier 112 generally modifies the received transaction request to account for transaction overheads that will be incurred in committing the transaction to blockchain 122 for processing and recordation such that a single transaction is recorded on the blockchain to transfer a quantity of the first type of token from a transmitter wallet to the receiver wallet in exchange for some defined payload included in the transaction request. Generally, in modifying a transaction, transaction modifier uses one or more policies stored in policy repository 116 to identify the rules to apply to an incoming transaction to accurately modify the received transaction request to reflect the party that is responsible for covering the transaction overhead associated with a transaction.

In some aspects, the policy may indicate that the user associated with the transmitter wallet is the party that will cover the transaction overhead associated with the transaction. In such a case, the total amount of the first type of token to withdraw from the transmitter wallet will be the amount of the first type of token indicated in the received transaction request plus an amount of the first type of token that is determined to be equivalent to the transaction overhead for processing the transaction on the blockchain, which, as discussed, may be denominated in a second type of token, such as a native token for the blockchain. Based on this policy, transaction modifier 112 can modify the received transaction request to include a plurality of transfers between different wallets that collectively causes the transaction to be executed. In this example, the transaction request may thus be modified by transaction modifier 112 to effectuate (1) a transfer of the amount of the first token specified in the received transaction request from the transmitter wallet to a receiver wallet; (2) a transfer of the amount of the first type of token that is determined to be equivalent to the transaction overhead for processing the transaction on the blockchain from the transmitter wallet to a wallet associated with the relay service 110; and (3) a transfer of the amount of the second token from the wallet associated with the relay service 110 for covering the transaction overhead for the transaction.

In some aspects, the policy may indicate that the user associated with the receiver wallet is the party that will cover the transaction overhead associated with the transaction (or at least a portion of the transaction overhead associated with the transaction). In this case, the total amount of the first type of token to withdraw from the transmitter wallet may be the same as the amount specified in the transaction request received at relay service 110. However, the amount received at the receiver wallet may be the difference between the amount specified in the transaction request received at relay service and the amount of the first type of token that is determined to be equivalent to the transaction overhead for processing the transaction on the blockchain. The transaction request may thus be modified by transaction modifier 112 to effectuate (1) a transfer of the amount of the first token specified in the received transaction request, less the amount of the first type of token that is determined to be equivalent to the transaction overhead for processing the transaction on the blockchain, from the transmitter wallet to a receiver wallet; (2) a transfer of the amount of the first type of token that is determined to be equivalent to the transaction overhead for processing the transaction on the blockchain, from the transmitter wallet to a wallet associated with the relay service 110; and (3) a transfer of the amount of the second token from the wallet associated with the relay service 110 for covering the transaction overhead for the transaction.

In some aspects, transaction modifier 112 may maintain a running total of transaction overhead amounts covered by the relay service 110 and may periodically settle aggregated transaction overhead amounts with one or more parties conducting transactions through relay service 110. In such a case, transaction modifier 112 can modify a received transaction to allow for the amount of the first token specified in the transaction request to be transferred from the transmitter wallet to the receiver wallet. To cover the transaction overhead associated with the transaction, the amount of the second type of token needed to cover the transaction overhead may be transferred from a wallet associated with the relay service 110. The amount of the transaction overhead covered by the relay service 110 may be accumulated as a cumulative total (or running total) of the second type of token, irrespective of the current exchange rate between the first type of token and the second type of token, or may be accumulated as a running total of the amount of the first type of token determined to be equivalent to the transaction overhead denominated in the second type of token at the time the transaction was received. This running total may be used to periodically transfer tokens from a recipient wallet or transmitter wallet to the wallet associated with relay service 110 in order to cover the accumulated transaction overhead from multiple transactions involving the receiver wallet or transmitter wallet, as discussed in further detail below.

In some aspects, a policy may specify a maximum amount of transaction overheads that the user associated with the recipient wallet will cover before passing the transaction overhead for any transaction committed to blockchain 122 to the user associated with the transmitter wallet. This defined maximum amount may be specified as a maximum amount, denominated in the first token, that the user associated with the recipient wallet will cover over a defined time period (e.g., every calendar month, biweekly, etc.). When the accumulated amount of transaction overhead costs incurred in performing transactions with the user of the recipient wallet is below the defined maximum amount, transaction modifier 112 can modify the transaction to cause the user associated with the transmitter wallet to receive, upon execution of a transaction, an amount of the first type of token that is the difference between the amount of the first type of token specified in the transaction request and the amount of the first type of token determined to be equivalent to the transaction overhead denominated in the second type of token. After the accumulated amount of transaction overhead costs reaches the defined maximum amount, transaction modifier 112 can modify the transaction to cause the user associated with the transmitter wallet to have withdrawn the amount of the first type of token specified in the transaction request and the amount of the first type of token determined to be equivalent to the transaction overhead denominated in the second type of token.

In some aspects, a policy may specify an amount (e.g., a percentage) of the transaction overhead that the user associated with the transmitter wallet is responsible for covering and a corresponding amount of the transaction overhead that the user associated with the receiver wallet is responsible for covering. In this example, transaction modifier 112 can modify the received transaction request to reflect the distribution of transaction overhead costs between the receiver wallet and the transmitter wallet. The transaction, for example, may be modified such that the user associated with the receiver wallet receives an amount of the first type of token calculated to be the difference between the amount of the first type of token specified in the transaction request and an amount of the first type of token determined to be equivalent to the portion of the transaction overhead, denominated in the second type of token, that the user associated with the receiver wallet will cover (according to the policy defined for the user associated with the transmitter wallet). The transaction may further be modified such that the user associated with the transmitter wallet transmits, to the receiver wallet and/or the wallet associated with the relay service 110, an amount of the first type of token calculated to be the sum of the amount of the first type of token specified in the transaction request and the amount of the first type of token determined to be equivalent to the portion of the transaction overhead, denominated in the second type of token, that the user associated with the transmitter wallet will cover.

In some aspects, to cover the transaction overhead associated with a transaction, the transaction overhead may be withdrawn from the recipient wallet instead of from a wallet associated with the relay service. In this example, it may be assumed that the user associated with the recipient wallet has a sufficient amount of the second type of token to cover the transaction overhead cost for processing a transaction on blockchain 122. In modifying a transaction, transaction modifier 112 can replace the transfer of tokens from the wallet associated with the relay service 110 (as discussed above) to the blockchain with a transfer of tokens from the recipient wallet to the blockchain 122.

After modifying a transaction request according to a policy defined for one or both of the user associated with the transmitter wallet and the user associated with the receiver wallet, as discussed above, the modified transaction may be passed to transaction executor 114 for execution. To perform a transaction, transaction executor 114 can invoke one or more operations at blockchain 122 in order to cause tokens and/or other digital assets to be transferred between the defined recipient wallet and transmitter wallet in the received transaction request. In some aspects, the set of transactions which transaction modifier 112 can define for a given transaction request may be treated as an atomic set of transactions, such that successful execution of each transaction in the set of transactions corresponds to execution of the incoming transaction request on the blockchain 122. For example, the transfer of an amount of the first type of token from the transmitter wallet to the receiver wallet, an amount of the first type of token determined to be the equivalent of a transaction overhead, denominated as an amount in the second type of token, in terms of the first type of token transferred from one or both of the transmitter wallet or the receiver wallet, and an amount of the first type of token expected to be used in order to cover transaction costs on blockchain 122.

In some aspects, transaction modifier 112 and/or transaction executor 114 can output requests to commit a transaction record to blockchain 122 based on the current transaction overhead associated with a transaction and policies defining, for example, a maximum transaction overhead amount that a receiving party will cover on a per-transaction basis. If the current transaction overhead for processing a transaction on blockchain 122 exceeds a defined amount (e.g., due to heavy traffic on the blockchain 122 or a large number of pending transactions on the blockchain 122), transaction modifier 112 and/or transaction executor 114 can delay processing the transaction until the transaction overhead falls below the defined amount. By doing so, the dispatch of transaction records to blockchain 122 for processing may be delayed to minimize, or at least reduce, latency between outputting a request to commit a transaction record to blockchain 122 and commitment of the transaction record to blockchain 122. Further, transaction records may be committed to blockchain 122 when compute resources are available for processing, which may efficiently use compute resources on devices participating in processing and verifying transactions on the blockchain 122.

In some aspects, to commit a transaction record to blockchain 122, transaction executor 114 can invoke one or more programmatic constructs at blockchain 122 to record the transaction on blockchain 122 and cause tokens to be transferred between a transmitter wallet and a receiver wallet, and in some aspects a wallet associated with the relay service 110. The programmatic construct invoked at blockchain 122 may be, for example, a smart contract defined for transferring tokens between a transmitter wallet and a receiver wallet. The smart contract may, in some aspects, be used to validate a transaction and implement the distribution of tokens amongst the transmitter wallet, the receiver wallet, the wallet associated with the relay service, and the blockchain 122 itself, so that a policy defining the party or parties which are covering the transaction overhead for any transaction executed on blockchain 122 (as discussed above with respect to the modification of a transaction by transaction modifier 112) is implemented.

### Example Transaction Execution on a Blockchain Through a Relay Service for Managing Transaction Overhead Coverage

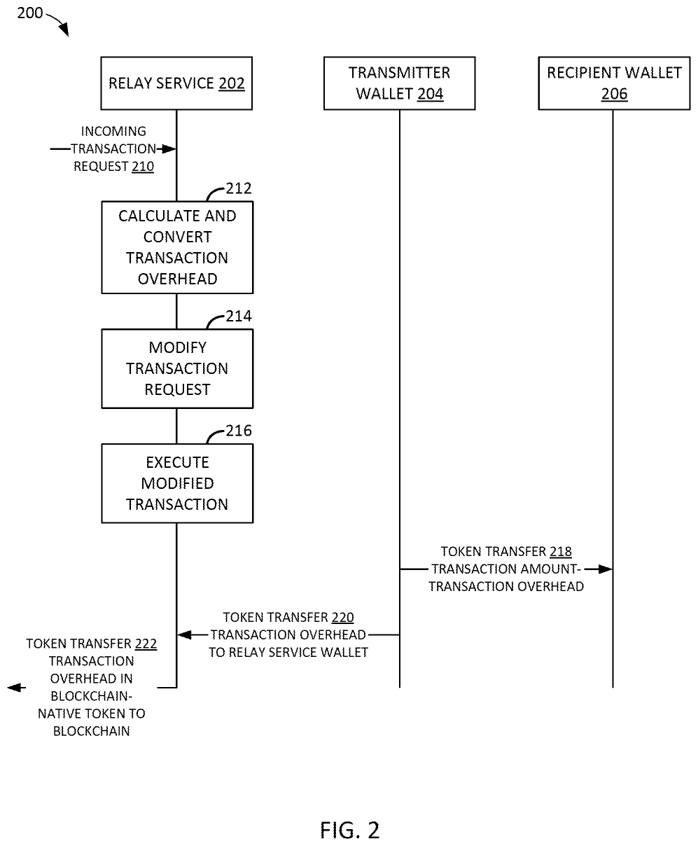

FIG. 2 is a flow diagram 200 illustrating execution of a transaction on a blockchain through a relay service in which the recipient of the transaction incurs the transaction overhead for performing the transaction on the blockchain, according to embodiments of the present disclosure. Flow diagram 200 illustrates an example in which a policy defined for the recipient of the transaction specifies that the recipient of the transaction covers the transaction overhead, or at least a portion of the transaction overhead, and that neither the transmitter wallet nor the recipient wallet are involved in transferring native tokens to the blockchain to cover the transaction overhead.

As illustrated, a transaction request 210 is received at relay service 202 (which may correspond to relay service 110 illustrated in FIG. 1). The transaction request generally specifies the recipient wallet, the transmitter wallet, the amount of a first type of token to be transferred between the transmitter wallet 204 and the recipient wallet 206. Based on the identification of the recipient wallet, relay service 202 can retrieve a policy defined for the user associated with the recipient wallet and use this policy to modify the received transaction request 210 so that execution of the transaction may involve a transfer of the first type of token, but not of a second type of token (e.g., a native token for the blockchain on which transaction records are to be committed and verified), between transmitter wallet 204 and recipient wallet 206. As discussed, by doing so, aspects of the present disclosure may allow for users conducting transactions through relay service 202 to maintain a balance in a first type of token without needing to maintain a balance in a second type of token or conduct additional transactions to exchange the first type of token for the second type of token.

At block 212, relay service 202 calculates the transaction overhead that is expected to be incurred by processing the transaction on the blockchain. The transaction overhead may be, for example, broadcast by the blockchain and may be denominated in a second type of token (e.g., a native token for the blockchain). The transaction overhead may be converted from the second type of token to an equivalent amount of the first type of token. For example, the transaction overhead may be converted from the second type of token to the first type of token based on a current exchange rate for converting the first type of token to the second type of token.

At block 214, relay service 202 modifies the transaction request based on the amount of the first type of token and the policy for the user associated with the recipient wallet specifying that the user associated with the recipient wallet is responsible for covering the transaction overhead for the transaction and that the relay service 202 will cover the transaction overhead on behalf of the user associated with the recipient wallet. Thus, the transaction request may be modified so that (1) the transmitter wallet 204 transfers out the amount of the first type of token specified in transaction request 210, (2) the recipient wallet 206 receives the amount of the first type of token specified in transaction request 210, less the amount of the transaction overhead in the first type of token determined to be equivalent to the transaction overhead in the second type of token, (3) the wallet associated with the relay service 202 receives the amount of the transaction overhead in the first type of token determined to be equivalent to the transaction overhead in the second type of token, and (4) the wallet associated with the relay service 202 outputs the transaction overhead in the second type of token to the blockchain to cover the transaction overhead.

At block 216, relay service 202 executes the modified transaction. As discussed, relay service 202 can invoke a smart contract or other programmatic construct on the blockchain to perform each of the transactions discussed above and record the transaction request 210 on the blockchain.

In executing the transaction, thus, a first token transfer 218 may be performed between the transmitter wallet 204 and the recipient wallet 206. Based on the policy specifying that the user associated with the recipient wallet is to cover the transaction overhead, the first token transfer 218 may be an amount of the first type of token determined to be the difference between the transaction amount specified in transaction request 210 (in the first type of token) and the amount of the transaction overhead in the first type of token determined to be equivalent to the transaction overhead in the second type of token. To cover the transaction overhead, a second token transfer 220 may be performed between the transmitter wallet 204 and the relay service 202 to transfer the amount of the transaction overhead in the first type of token determined to be equivalent to the transaction overhead in the second type of token to the relay service 202. The relay service 202 may perform a third token transfer 222 to cover the transaction overhead. Token transfer 222 may be denominated in a second type of token (e.g., a blockchain-native token) and may be output to the blockchain to cover the transaction overhead involved in processing the transaction.

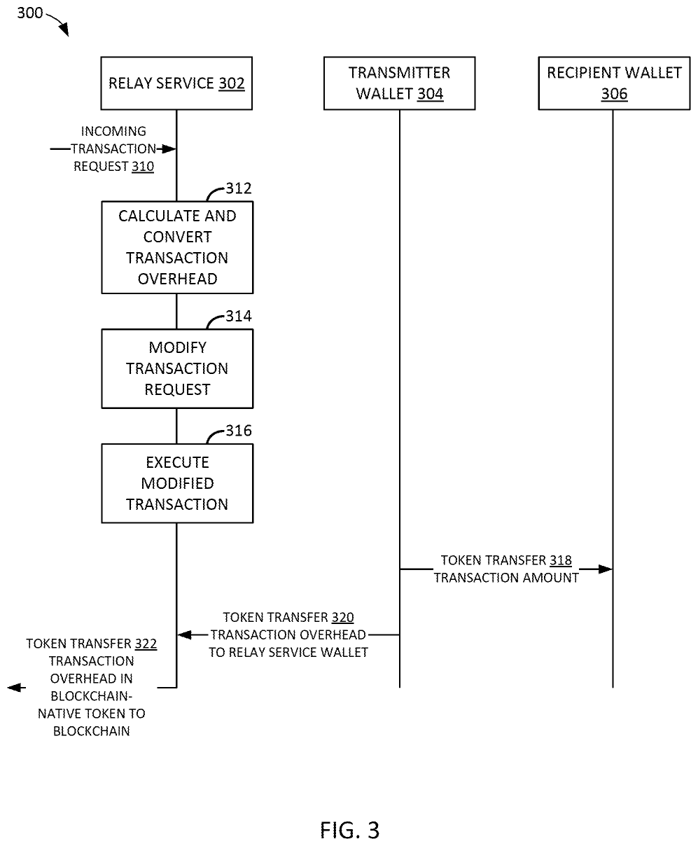

FIG. 3 is a flow diagram 300 illustrating execution of a transaction on a blockchain through a relay service in which the transmitter associated with the transaction incurs the transaction overhead for performing the transaction on the blockchain, according to embodiments of the present disclosure. Flow diagram 300 illustrates an example in which a policy defined for recipient of the transaction specifies that the user associated with the transmitter wallet covers the transaction overhead, or at least a portion of the transaction overhead, and that neither the transmitter wallet nor the recipient wallet are involved in transferring native tokens to the blockchain to cover the transaction overhead.

As illustrated, a transaction request 310 is received at relay service 302 (which may correspond to relay service 110 illustrated in FIG. 1). The transaction request generally specifies the recipient wallet, the transmitter wallet, the amount of a first type of token to be transferred between the transmitter wallet 304 and the recipient wallet 306. Based on the identification of the recipient wallet, relay service 302 can retrieve a policy defined for the user associated with the recipient wallet and use this policy to modify the received transaction request 310 so that execution of the transaction may involve a transfer of the first type of token, but not of a second type of token (e.g., a native token for the blockchain on which transaction records are to be committed and verified), between transmitter wallet 304 and recipient wallet 306. As discussed, by doing so, aspects of the present disclosure may allow for users conducting transactions through relay service 302 to maintain a balance in a first type of token without needing to maintain a balance in a second type of token or conduct additional transactions to exchange the first type of token for the second type of token.

At block 312, relay service 302 calculates the transaction overhead that is expected to be incurred by processing the transaction on the blockchain. The transaction overhead may be, for example, broadcast by the blockchain and may be denominated in a second type of token (e.g., a native token for the blockchain). The transaction overhead may be converted from the second type of token to an equivalent amount of the first type of token. For example, the transaction overhead may be converted from the second type of token to the first type of token based on a current exchange rate for converting the first type of token to the second type of token.

At block 314, relay service 302 modifies the transaction request based on the amount of the first type of token and the policy for the user associated with the recipient wallet specifying that the user associated with the transmitter wallet is responsible for covering the transaction overhead for the transaction and that the relay service 302 will cover the transaction overhead on behalf of the user associated with the transmitter wallet. Thus, the transaction request may be modified so that (1) the transmitter wallet 304 transfers out the amount of the first type of token specified in transaction request 310 plus the amount of the transaction overhead in the first type of token determined to be equivalent to the transaction overhead in the second type of token, (2) the recipient wallet 306 receives the transaction amount in the first type of token, (3) the wallet associated with the relay service 302 receives the amount of the transaction overhead in the first type of token determined to be equivalent to the transaction overhead in the second type of token, and (4) the wallet associated with the relay service 302 outputs the transaction overhead in the second type of token to the blockchain to cover the transaction overhead.

At block 316, relay service 302 executes the modified transaction. As discussed, relay service 302 can invoke a smart contract or other programmatic construct on the blockchain to perform each of the transactions discussed above and record the transaction request 310 on the blockchain.

In executing the transaction, thus, a first token transfer 318 may be performed between the transmitter wallet 304 and the recipient wallet 306. Based on the policy specifying that the user associated with the recipient wallet is to cover the transaction overhead, the first token transfer 318 may be the transaction amount specified in transaction request 310 (in the first type of token). To cover the transaction overhead, a second token transfer 320 may be performed between the transmitter wallet 304 and the relay service 302 to transfer the amount of the transaction overhead in the first type of token determined to be equivalent to the transaction overhead in the second type of token to the relay service 302. The relay service 302 may perform a third token transfer 322 to cover the transaction overhead. Token transfer 322 may be denominated in a second type of token (e.g., a blockchain-native token) and may be output to the blockchain to cover the transaction overhead involved in processing the transaction.

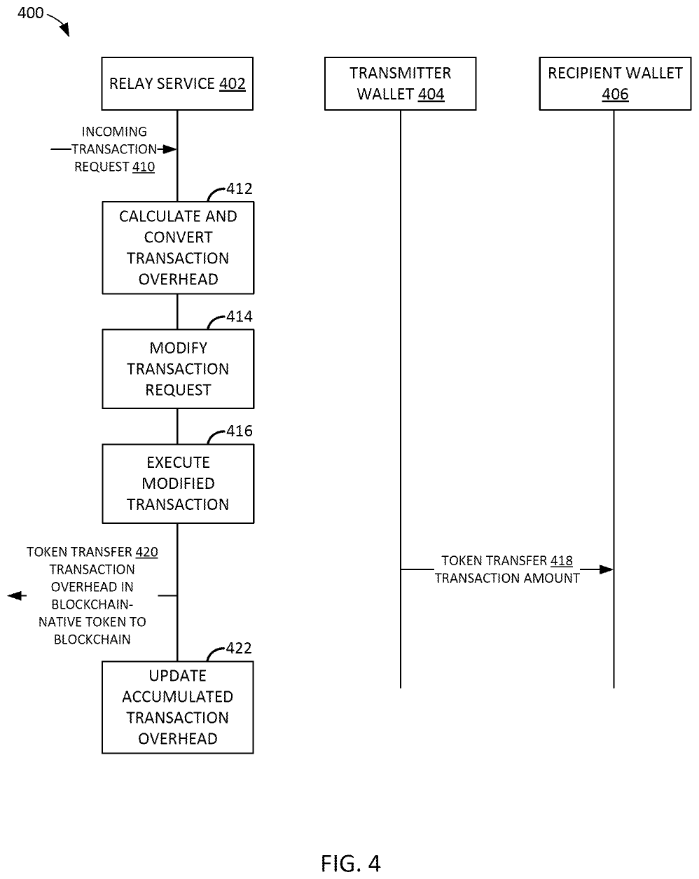

FIG. 4 is a flow diagram 400 illustrating execution of a transaction on a blockchain through a relay service in which a relay service incurs the transaction overhead for performing the transaction on the blockchain, according to embodiments of the present disclosure. Flow diagram 400 illustrates an example in which a policy defined for the user associated with the recipient specifying that the relay service covers the transaction overhead on behalf of the recipient of the transaction.

As illustrated, a transaction request 410 is received at relay service 402 (which may correspond to relay service 110 illustrated in FIG. 1). The transaction request generally specifies the recipient wallet, the transmitter wallet, the amount of a first type of token to be transferred between the transmitter wallet 404 and the recipient wallet 406. Based on the identification of the recipient wallet, relay service 402 can retrieve a policy defined for the user associated with the recipient wallet and use this policy to modify the received transaction request 410 so that execution of the transaction may involve a transfer of the first type of token, but not of a second type of token (e.g., a native token for the blockchain on which transaction records are to be committed and verified), between transmitter wallet 404 and recipient wallet 406. As discussed, by doing so, aspects of the present disclosure may allow for users conducting transactions through relay service 402 to maintain a balance in a first type of token without needing to maintain a balance in a second type of token or conduct additional transactions to exchange the first type of token for the second type of token.

At block 412, relay service 402 calculates the transaction overhead that is expected to be incurred by processing the transaction on the blockchain. The transaction overhead may be, for example, broadcast by the blockchain and may be denominated in a second type of token (e.g., a native token for the blockchain). The transaction overhead may be converted from the second type of token to an equivalent amount of the first type of token. For example, the transaction overhead may be converted from the second type of token to the first type of token based on a current exchange rate for converting the first type of token to the second type of token.

At block 414, relay service 402 modifies the transaction request based on the amount of the first type of token and the policy for the user associated with the recipient wallet specifying that the relay service 402 will cover the transaction overhead for the transaction on behalf of the user associated with the recipient wallet 406. Thus, the transaction request may be modified so that (1) the transmitter wallet 404 transfers to the recipient wallet 406 the amount of the first type of token specified in transaction request 410, (2) the transmitter wallet 404 transfers to the wallet associated with the relay service 402 the amount of the transaction overhead in the first type of token determined to be equivalent to the transaction overhead in the second type of token, and (3) the wallet associated with the relay service 402 outputs the transaction overhead in the second type of token to the blockchain to cover the transaction overhead.

At block 416, relay service 402 executes the modified transaction. As discussed, relay service 402 can invoke a smart contract or other programmatic construct on the blockchain to perform each of the transactions discussed above and record the transaction request 410 on the blockchain.

In executing the transaction, thus, a first token transfer 418 may be performed between the transmitter wallet 404 and the recipient wallet 406. Based on the policy specifying that the relay service 402 is to cover the transaction overhead on behalf of the recipient wallet, the first token transfer 418 may be the transaction amount specified in transaction request 410 (in the first type of token). To cover the transaction overhead, a second token transfer 420 may be performed by the relay service 402 to the blockchain. At block 422, the relay service 402 updates an accumulated transaction overhead paid on behalf of the user associated with recipient wallet 406. The accumulated transaction overhead may be demonimated in the non-native token for the blockchain. At various points in time (e.g., periodically, as the accumulated transaction overhead reaches a specified amount, etc.), the relay service can withdraw the accumulated transaction overhead from the recipient wallet to the wallet associated with the relay service 402.

It should be recognized that the examples of transactions described in FIGS. 2 through 4 are illustrative examples of transactions that may be performed between a transmitter wallet and a receiver wallet through a relay service such that a first type of token, but not a second type of token, are transferred between the transmitter wallet and the receiver wallet. Other distributions, for example, of the transaction overhead between the transmitter wallet, recipient wallet, and relay service may be performed. For example, a transaction overhead may be split between the transmitter wallet and the receiver wallet, while covered on behalf of the transmitter wallet and/or the receiver wallet by the relay service.

### Example Operations for Transaction Processing on a Blockchain Through a Relay Service for Managing Transaction Overhead Coverage

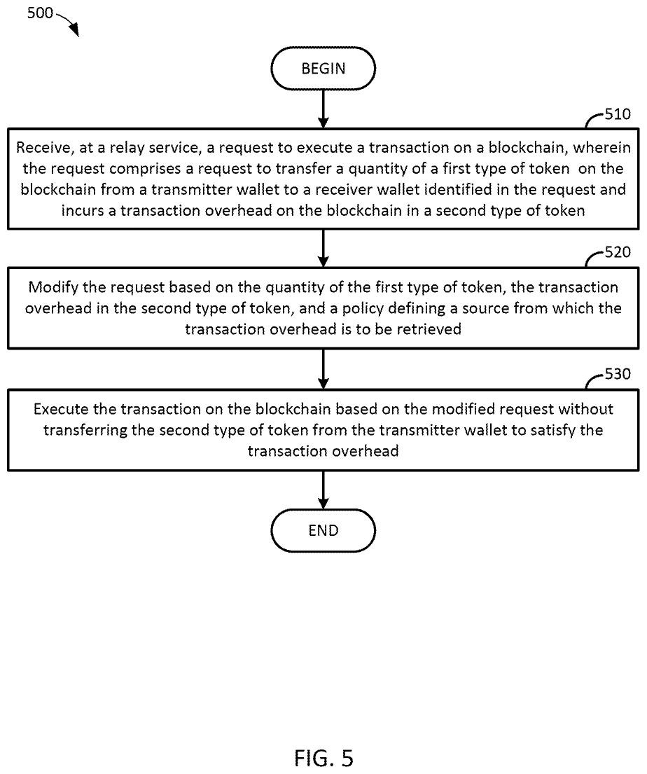

FIG. 5 illustrates example operations 500 for executing a transaction on a blockchain through a relay service, according to embodiments of the present disclosure. Operations 500 may be performed, for example, by a relay service (e.g., relay service 110 illustrated in FIG. 1) that users associated with a transmitter wallet and a receiver wallet use to execute transactions on a blockchain.

Operations 500, as illustrated, begin with block 510, with receiving, at a relay service, a request to execute a transaction on a blockchain. The request generally includes a request to transfer a quantity of a first type of token on the blockchain from a transmitter wallet to a receiver wallet identified in the request and incurs a transaction overhead on the blockchain in a second type of token.

At block 520, operations 500 proceed with modifying the request based on the quantity of the first type of token, the transaction overhead in the second type of token, and a policy defining a source from which the transaction overhead is to be retrieved.

In some aspects, modifying the request may include modifying the quantity of the first type of token to be transferred on the blockchain based on a quantity of the first type of token that is determined to be equivalent to the transaction overhead in the second type of token.

At block 530, operations 500 proceed with executing the transaction on the blockchain based on the modified request without transferring the second type of token from the transmitter wallet to satisfy the transaction overhead.

In some aspects, executing the transaction includes identifying a first source from which the quantity of the first type of token is to be retrieved and identifying a second source from which a quantity of the first type of token that is determined to be equivalent to the transaction overhead in the second type of token is to be retrieved. The transaction may be performed on the blockchain based on the identified first source and the identified second source.

In some aspects, the second source may comprise a third-party source associated with neither the transmitter wallet nor the receiver wallet. Operations 500 may further include incrementing a running total of the first type of token used to satisfy transaction overheads on the blockchain for a party associated with the receiver wallet based on the quantity of the first type of token that is determined to be equivalent to the transaction overhead in the second type of token, determining a difference between the running total and an amount covered by the third-party source according to the policy, and transferring the difference from a wallet associated with the receiver to a wallet associated with the third-party source.

In some aspects, the second source may be a same source as the first source. Operations 500 may further include transferring the quantity of the first type of token from the transmitter wallet to the receiver wallet, transferring the quantity of the first type of token that is determined to be equivalent to the transaction overhead in the second type of token from the transmitter wallet to a third-party wallet associated with a third-party source that is neither the transmitter wallet nor the receiver wallet, and using a quantity of the second type of token from the third-party wallet to cover the transaction overhead.

In some aspects, the policy specifies a proportion of the transaction overhead covered by transferring the second type of token from the receiver wallet.

In some aspects, the policy specifies a maximum cumulative amount of transaction overheads covered over a defined time period by transferring the second type of token from the receiver wallet.

In some aspects, the policy comprises a policy defined for a party associated with the receiver wallet.

### Example System for Transaction Processing on a Blockchain Through a Relay Service for Managing Transaction Overhead Coverage

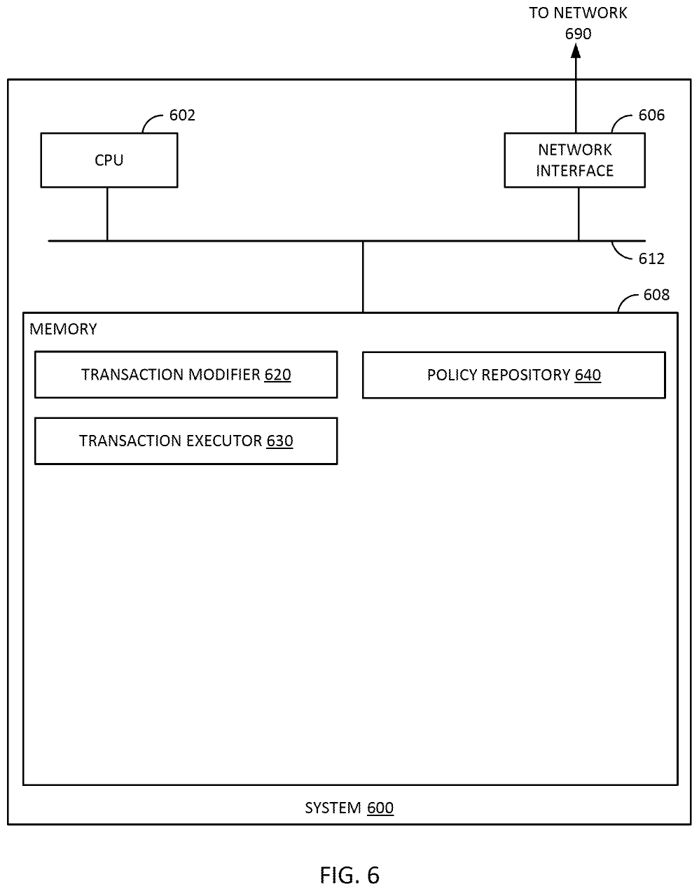

FIG. 6 illustrates an example system 600 configured to perform the methods described herein, including, for example, operations 500 of FIG. 5. In some embodiments, system 600 may act as a relay service through which transactions are modified prior to execution on a blockchain, such as relay service 110 illustrated in FIG. 1.

As shown, system 600 includes a central processing unit (CPU) 602, one or more I/O device interfaces 604 that may allow for the connection of various I/O devices 614 (e.g., keyboards, displays, mouse devices, pen input, etc.) to the system 600, network interface 606 through which system 600 is connected to network 690 (which may be a local network, an intranet, the internet, or any other group of computing devices communicatively connected to each other), a memory 608, and an interconnect 612. The I/O devices 614 and/or network interface 606 may be used to receive requests to bridge transactions between different blockchains, such as a Layer 1 blockchain and a Layer 2 blockchain.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608.

CPU 602 is included to be representative of a single CPU, multiple CPUs, a single CPU having multiple processing cores, and the like.

Memory 608 is representative of a volatile memory, such as a random access memory, or a nonvolatile memory, such as nonvolatile random access memory, phase change random access memory, or the like. As shown, memory 608 includes a transaction modifier 620, transaction executor 630, and policy repository 640.

Transaction modifier 620 generally corresponds to transaction modifier 112 illustrated in FIG. 1. Generally, transaction modifier 620 receives requests to perform transactions between a user associated with a transmitter wallet and a user associated with a recipient wallet on a blockchain. Transaction modifier 620 generally retrieves a policy from policy repository 640 to determine how coverage of the transaction overhead is to be distributed amongst the transmitter wallet, the receiver wallet, and a wallet associated with the relay service. Based on this policy, transaction modifier 620 modifies the received transaction request to account for the transaction overhead for the transaction. The total amount of a first type of token withdrawn from the transmitter wallet and received at one or both of the recipient wallet or the wallet associated with the relay service may be modified based on the policy and the amount of the first type of token determined to be equivalent to the transaction overhead denominated in the second type of token.

Transaction executor 630 receives the modified transaction from transaction modifier 620 and coordinates execution of the modified transaction to effectuate a transfer of the first type of token between the transmitter wallet, the receiver wallet, and (in some aspects) the wallet associated with the relay service. In executing the modified transaction, transaction executor 630 may execute the transfers of tokens between the transmitter wallet, the receiver wallet, the wallet associated with the relay service, and the blockchain as an atomic transaction. Transactions involving the transmitter wallet and the receiver wallet may involve a first type of token (e.g., a non-native token transferred on the blockchain) and may not involve a second type of token (e.g., a native token defined for the blockchain).

### Example Clauses

Implementation details for various aspects of the present disclosure are described in the following numbered clauses.

Clause 1: A computer-implemented method, comprising: receiving, at a relay service, a request to execute a transaction on a blockchain, wherein the request comprises a request to transfer a quantity of a first type of token on the blockchain from a transmitter wallet to a receiver wallet identified in the request and incurs a transaction overhead on the blockchain in a second type of token; modifying the request based on the quantity of the first type of token, the transaction overhead in the second type of token, and a policy defining a source from which the transaction overhead is to be retrieved; and executing the transaction on the blockchain based on the modified request without transferring the second type of token from the transmitter wallet to satisfy the transaction overhead.

Clause 2: The method of Clause 1, wherein modifying the request comprises modifying the quantity of the first type of token to be transferred on the blockchain based on a quantity of the first type of token that is determined to be equivalent to the transaction overhead in the second type of token.

Clause 3: The method of any one of Clauses 1 or 2, wherein executing the transaction comprises: identifying a first source from which the quantity of the first type of token is to be retrieved; identifying a second source from which a quantity of the first type of token that is determined to be equivalent to the transaction overhead in the second type of token is to be retrieved; and performing the transaction on the blockchain based on the identified first source and the identified second source.

Clause 4: The method of Clause 3, wherein the second source comprises a third-party source associated with neither the transmitter wallet nor the receiver wallet.

Clause 5: The method of Clause 4, further comprising: incrementing a running total of the first type of token used to satisfy transaction overheads on the blockchain for a party associated with the receiver wallet based on the quantity of the first type of token that is determined to be equivalent to the transaction overhead in the second type of token; determining a difference between the running total and an amount covered by the third-party source according to the policy; and transferring the difference from a wallet associated with the receiver to a wallet associated with the third-party source.

Clause 6: The method of any one of Clauses 3 through 5, wherein the second source comprises a same source as the first source.

Clause 7: The method of Clause 6, wherein executing the transaction on the blockchain comprises: transferring the quantity of the first type of token from the transmitter wallet to the receiver wallet; transferring the quantity of the first type of token that is determined to be equivalent to the transaction overhead in the second type of token from the transmitter wallet to a third-party wallet associated with a third-party source that is neither the transmitter wallet nor the receiver wallet; and using a quantity of the second type of token from the third-party wallet to cover the transaction overhead.

Clause 8: The method of any one of Clauses 1 through 7, wherein the policy specifies a proportion of the transaction overhead covered by transferring the second type of token from the receiver wallet.

Clause 9: The method of any one of Clauses 1 through 8, wherein the policy specifies a maximum cumulative amount of transaction overheads covered over a defined time period by transferring the second type of token from the receiver wallet.

Clause 10: The method of any one of Clauses 1 through 9, wherein the policy comprises a policy defined for a party associated with the receiver wallet.

Clause 11: A system, comprising: a memory having executable instructions stored thereon; and a processor configured to execute the executable instructions to perform the operations of any one of Clauses 1 through 10.

Clause 12: A system, comprising: means for performing the operations of any one of Clauses 1 through 10.

Clause 13: A computer-readable medium having instructions stored thereon which, when executed by a processor, performs the operations of any one of Clauses 1 through 10.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
receiving, at a relay service, a request to execute a transaction on a blockchain, wherein the request comprises a request to transfer a quantity of a first type of token on the blockchain from a transmitter wallet to a receiver wallet identified in the request and incurs a transaction overhead on the blockchain in a second type of token;
modifying the request based on the quantity of the first type of token, the transaction overhead in the second type of token, and a policy defining a source from which the transaction overhead is to be retrieved; and
executing the transaction on the blockchain based on the modified request without transferring the second type of token from the transmitter wallet to satisfy the transaction overhead.

2. The method of claim 1, wherein modifying the request comprises modifying the quantity of the first type of token to be transferred on the blockchain based on a quantity of the first type of token that is determined to be equivalent to the transaction overhead in the second type of token.

3. The method of claim 1, wherein executing the transaction comprises:
identifying a first source from which the quantity of the first type of token is to be retrieved;
identifying a second source from which a quantity of the first type of token that is determined to be equivalent to the transaction overhead in the second type of token is to be retrieved; and
performing the transaction on the blockchain based on the identified first source and the identified second source.

4. The method of claim 3, wherein the second source comprises a third-party source associated with neither the transmitter wallet nor the receiver wallet.

5. The method of claim 4, further comprising:
incrementing a running total of the first type of token used to satisfy transaction overheads on the blockchain for a party associated with the receiver wallet based on the quantity of the first type of token that is determined to be equivalent to the transaction overhead in the second type of token;
determining a difference between the running total and an amount covered by the third-party source according to the policy; and
transferring the difference from a wallet associated with the receiver to a wallet associated with the third-party source.

6. The method of claim 3, wherein the second source comprises a same source as the first source.

7. The method of claim 6, wherein executing the transaction on the blockchain comprises:
transferring the quantity of the first type of token from the transmitter wallet to the receiver wallet;
transferring the quantity of the first type of token that is determined to be equivalent to the transaction overhead in the second type of token from the transmitter wallet to a third-party wallet associated with a third-party source that is neither the transmitter wallet nor the receiver wallet; and
using a quantity of the second type of token from the third-party wallet to cover the transaction overhead.

8. The method of claim 1, wherein the policy specifies a proportion of the transaction overhead covered by transferring the second type of token from the receiver wallet.

9. The method of claim 1, wherein the policy specifies a maximum cumulative amount of transaction overheads covered over a defined time period by transferring the second type of token from the receiver wallet.

10. The method of claim 1, wherein the policy comprises a policy defined for a party associated with the receiver wallet.

11. A system, comprising:
a memory having executable instructions stored thereon; and
a processor configured to execute the executable instructions to cause the system to:
receive, at a relay service, a request to execute a transaction on a blockchain, wherein the request comprises a request to transfer a quantity of a first type of token on the blockchain from a transmitter wallet to a receiver wallet identified in the request and incurs a transaction overhead on the blockchain in a second type of token;
modify the request based on the quantity of the first type of token, the transaction overhead in the second type of token, and a policy defining a source from which the transaction overhead is to be retrieved; and
execute the transaction on the blockchain based on the modified request without transferring the second type of token from the transmitter wallet to satisfy the transaction overhead.

12. The system of claim 11, wherein in order to modify the request, the processor is configured to cause the system to modify the quantity of the first type of token to be transferred on the blockchain based on a quantity of the first type of token that is determined to be equivalent to the transaction overhead in the second type of token.

13. The system of claim 11, wherein in order to execute the transaction, the processor is configured to cause the system to:
identify a first source from which the quantity of the first type of token is to be retrieved;
identify a second source from which a quantity of the first type of token that is determined to be equivalent to the transaction overhead in the second type of token is to be retrieved; and
perform the transaction on the blockchain based on the identified first source and the identified second source.

14. The system of claim 13, wherein:
the second source comprises a third-party source associated with neither the transmitter wallet nor the receiver wallet; and
the processor is further configured to cause the system to:
increment a running total of the first type of token used to satisfy transaction overheads on the blockchain for a party associated with the receiver wallet based on the quantity of the first type of token that is determined to be equivalent to the transaction overhead in the second type of token;
determine a difference between the running total and an amount covered by the third-party source according to the policy; and
transfer the difference from a wallet associated with the receiver to a wallet associated with the third-party source.

15. The system of claim 13, wherein the second source comprises a same source as the first source.

16. The system of claim 15, wherein in order to execute the transaction on the blockchain, the processor is configured to cause the system to:
transfer the quantity of the first type of token from the transmitter wallet to the receiver wallet;
transfer the quantity of the first type of token that is determined to be equivalent to the transaction overhead in the second type of token from the transmitter wallet to a third-party wallet associated with a third-party source that is neither the transmitter wallet nor the receiver wallet; and
use a quantity of the second type of token from the third-party wallet to cover the transaction overhead.

17. The system of claim 11, wherein the policy specifies a proportion of the transaction overhead covered by transferring the second type of token from the receiver wallet.

18. The system of claim 11, wherein the policy specifies a maximum cumulative amount of transaction overheads covered over a defined time period by transferring the second type of token from the receiver wallet.

19. The system of claim 11, wherein the policy comprises a policy defined for a party associated with the receiver wallet.

20. A computer-readable medium having instructions stored thereon which, when executed by a processor, performs an operation comprising:
receiving, at a relay service, a request to execute a transaction on a blockchain, wherein the request comprises a request to transfer a quantity of a first type of token on the blockchain from a transmitter wallet to a receiver wallet identified in the request and incurs a transaction overhead on the blockchain in a second type of token;
modifying the request based on the quantity of the first type of token, the transaction overhead in the second type of token, and a policy defining a source from which the transaction overhead is to be retrieved; and
executing the transaction on the blockchain based on the modified request without transferring the second type of token from the transmitter wallet to satisfy the transaction overhead.
